(19) United States
(12) Patent Application Publication
(10) Pub. No.: US 2004/0238008 A1
(43) Pub. Date: Dec. 2, 2004

(54) Systems and methods for cleaning semiconductor substrates using a reduced volume of liquid

(76) Inventors: Stephen E. Savas, Fremont, CA (US); John Zajac, San Jose, CA (US); Carl J. Galewski, Santa Cruz, CA (US)

Correspondence Address: PRITZKAU PATENT GROUP, LLC, 993 GAPTER ROAD, BOULDER, CO, 80303, US

(21) Appl. No.: 10/473,317

(22) PCT Filed: Mar. 12, 2003
(86) PCT No.: PCT/US03/07743

(51) Int. Cl. B08B 5/04

(52) U.S. Cl. 134/21; 134/33; 134/137

(57) ABSTRACT

Embodiments of the present invention are directed toward cleaning semiconductor substrates by dividing a processing chamber into a high-pressure compartment and a low-pressure compartment using a baffle. The baffle may include a pattern of nozzles that provide a flow path between the high pressure compartment and the low pressure compartment and that maintain the two compartments at substantially different pressures. A ratable substrate support is positioned within the low pressure compartment, and an inlet port injects a cleaning mist and a carrier gas into the high pressure compartment. The pressure differential between the two compartments accelerates the droplets from the cleaning mist through the nozzles of the baffle into the low pressure compartment toward the substrate, where a portion of the cleaning mist impacts on the surface of the substrate to form a liquid film or to eject elements of the surface film on the wafer. The substrate support is configured to rotate the substrate such that the liquid film flows radially across the substrate. There may be an independent source of vapor of the same or different type as the mist which is introduced into the low pressure region and provides for liquid condensation on the wafer. This helps replace the liquid lost by splashing or centrifugal flow off the wafer edge. Waste products from micro features on the substrate diffuse into the liquid film, where portions of the liquid film and diffused waste products are eventually radially propelled off the edge of the substrate to be collected as waste or splashed off. Embodiments of the present invention are capable of cleaning a substrate with a significantly reduced volume of liquid relative to a conventional liquid bath.

### FIELD OF THE INVENTION

The present invention relates in general to systems and methods for cleaning semiconductor substrates, and more particularly, to systems and methods for cleaning semiconductor substrates using a reduced volume of liquid.

### BACKGROUND OF THE INVENTION

Current methods for cleaning semiconductor substrates typically involve immersing the substrate to be cleaned into a liquid bath. The liquid bath typically contains significant amounts of dissolved agents, such as solvents, acids, or bases, which react with contaminants and impurities on the surface of the substrate. A flow of liquid or gas in the bath such that gas bubbles or cleaning liquid pass across the surface of the substrate to affect cleaning. An ultrasonic or megasonic transducer may also be used to project energy into the liquid bath. This projected energy agitates the cleaning solution and causes the liquid bath to exert pressure whilst in contact with the surface of the substrate, thereby further enhancing the cleaning process.

One problem commonly associated with these conventional cleaning methods is that these methods typically require a large volume of liquid in the liquid bath. A large volume of liquid may be required, for example, to dilute the reactive agents or reduce the potential for re-deposition of contaminants on the substrate surface. Because the waste stream produced from conventional cleaning baths typically contain large amounts of corrosive and/or toxic chemical wastes, handling and disposing of large volumes of liquid waste can prove not only hazardous, but also very expensive. Furthermore, approaches using a liquid bath may be ineffective in completely removing contaminants from the semiconductor substrate due to the relatively slow flow speed (which, in some cases, may be less than 1 cm per second) of the liquid bath across the surface of the substrate. These relatively low flow speeds limit the exchange of, fresh cleaning liquid at the substrate surface and may increase the potential for a reflux of waste products to be re-deposited back onto the substrate.

Therefore, in light of the inefficiency of existing approaches, there is a need for systems and methods that can effectively clean semiconductor substrates using a much reduced volume of liquid and thereby significantly reduce the production of hazardous waste and associated handling and disposal costs.

### SUMMARY OF THE INVENTION

Embodiments of the present invention are generally directed to greatly reducing the volume of liquid required to effectively clean a semiconductor substrate. In one embodiment, a processing chamber for processing the substrate is divided into a high pressure compartment and a low pressure compartment separated by a baffle. The baffle may include a number holes or nozzles formed in the baffle that provide a flow path between the high pressure compartment and the low pressure compartment. A substrate to be cleaned is mounted in the low pressure compartment on a ratable substrate holder, and a vapor of cleaning liquid or cleaning liquid droplets entrained in an inert carrier gas is injected into the high pressure compartment. The pressure differential between the two compartments the causes the carrier gas and entrained droplets from the liquid vapor to accelerate from the high-pressure compartment, through the holes or nozzles formed in the baffle, and into the low pressure compartment toward the substrate surface. Some droplets propagated toward the substrate-impact on the surface of the substrate and may then condense to form a liquid layer or film on part or all of said substrate surface. The substrate may then be cleaned by rotating the substrate at a speed sufficient to radially propel the liquid film across the microfeatures of the substrate, and thence off the edge of the substrate to be collected as waste. In some embodiments a vapor having low partial pressures (<1 Torr) may also be introduced by a separate inlet into the low pressure region of the process system. This vapor, whether water or alcohol or other liquid vapor or mixture thereof, condenses on the surface of the wafer to enhance the formation of the liquid film covering the wafer surface.

During processing the liquid film is in contact with the microfeatures on the substrate surface, and condensation from new impacting cleaning droplets and possibly vapor replenish the surface film as the film is propelled off the edge of the substrate. This liquid film is agitated very strongly by the impact of the fast droplets projected from the nozzles which helps to clean waste products away from the vicinity of the microfeatures in accordance with desired cleaning characteristics. For example, the speed at which the substrate is rotated can be adjusted to increase the centrifugal flow speed of the liquid film across the surface of the substrate and thereby reduce the thickness of the film providing a higher replenishment rate and avoid re-deposition of waste products. The flow rate of the carrier gas and amount of liquid mist that are injected into the high pressure compartment may also be adjusted, along with the vapor provided directly to the process region to provide the desired agitation of the liquid film. This provides a balance in which the mass of liquid lost from the liquid film as a result of centrifugal force or splashing is replenished by new droplets of liquid and by vapor condensing on the rotating substrate. The thickness of the liquid film may also be controlled by adjusting the rotational speed of the substrate holder based, at least in part, on the droplet arrival rate or condensation rate. As another control mechanism influencing the substrate treatment adjusting the temperature of the substrate (which may be held in close thermal contact with the support pedestal). Or the carrier gas or cleaning liquid may also be used. Accordingly, by controlling the rotational speed of the substrate, the vapor pressure of all species in the low pressure region, the temperature of the substrate, and the flow rates of the carrier gas and liquid mist, the centrifugal flow velocity and thickness of the liquid film on the substrate can be adjusted. Hence the cleaning characteristics of the liquid film can be influenced and optimized for any particular application.

The level of agitation of the liquid film on the surface of the substrate may also be controlled by adjusting the pressure differential between the high pressure compartment and the low pressure compartment to control the velocity (at the nozzle exit) of the droplets propagated toward the semiconductor substrate. The velocity of the droplets upon impact on the wafer surface will also be a function of the distance from the barrier plate to the wafer and the gas pressure in the low-pressure region. Pressures in this region of less than 10 Torr are desirable because the droplet speed will not be too much attenuated by drag of the droplets in the ambient gas of the low pressure chamber. Because impinging droplets of the liquid mist produce localized and randomized energy deposition into the liquid film, the force of impact of the droplets onto the liquid film provides agitation of the liquid film, without producing waves (as may be produced in an ultrasonic or megasonic liquid cleaning bath). The number, size, and pattern of nozzles formed in the baffle, and the distance between the baffle and substrate, can also be adjusted to control the spatial distribution of the droplets as they impinge on the substrate. In one embodiment, for example, the baffle is configured to allow the coverage area of a nozzle to partially overlap with the coverage area of adjacent nozzles so as to provide uniform coverage of 30 the wafer surface.

The chemical composition of the liquid mist and the vapor in the low pressure region, and the resulting liquid film on the wafer may be controlled to form a substantially water-based solution, which may included a solvent, alcohol, trichloroethylene, base, acid or another liquid or mixture that may be used for cleaning semiconductor substrates. The vapor in the process region may also be predominantly of surface tension active species (alcohol, solvent) so as to provide for reduced droplet formation and avoidance of “water spots” on the wafer. The liquid mist may also include additives, such as a surfactant, for controlling the surface tension, viscosity or polarity of the liquid, which in turn influence the thickness of the liquid film or the speed at which the liquid flows across the substrate. The cleaning process may consist of multiple steps in which the composition of the impacting droplets and the vapor introduced to the low-pressure region are varied from one step to the next to produce the desired process result of a clean wafer. It may be desirable to have the final step use predominantly alcohol vapor, with or without droplet impact, to reduce the “water spotting” on the wafer.

One benefit of adding liquid onto the wafer surface by condensation from vapor in the low-pressure region is that introduction of particulates onto the substrate may be more effectively avoided. The rate of condensation of liquid onto the wafer may be well controlled by this method of introduction.

### BRIEF DESCRIPTION OF THE DRAWINGS

These and other features and advantages of the present invention will become more apparent to those skilled in the art from the following detailed description in conjunction with the appended drawings in which:

FIG. 1 illustrates a schematic side view of an exemplary processing system for cleaning a semiconductor substrate in accordance with the principles of the present invention;

FIGS. 2A-F illustrate exemplary configurations of baffle nozzles;

FIGS. 3A-C illustrate exemplary nozzle patterns in a plan view of a baffle;

FIG. 4 illustrates exemplary cone-shaped distribution patterns of carrier gas and liquid mist as they propagate through a nozzle toward a semiconductor substrate;

FIG. 5 illustrates a schematic side view of a droplet impinging upon an elemental column of liquid in the liquid film, and the radial movement of the elemental column toward the edge of a semiconductor substrate;

FIG. 6 illustrates an exemplary vacuum pumping system for removing gases and liquids from the processing chamber; and

FIG. 7 illustrates an exemplary liquid collection system for removing liquid from the high pressure compartment, and an exemplary back-flushing system for unclogging the nozzles of the baffle.

### DETAILED DESCRIPTION OF ILLUSTRATIVE EMBODIMENTS

Aspects of the present invention provide systems and methods for processing semiconductor substrates. The following description is presented to enable a person of ordinary skill in the art to make and use the invention. Descriptions of specific applications are provided only as examples. Various modifications, substitutions and variations of the preferred embodiment will be readily apparent to those of ordinary skill in the art, and the generic principles defined herein may be applied to other embodiments and applications without departing from the spirit and scope of the invention. Thus, the present invention is not intended to be limited to the described or illustrated embodiments, and should be accorded the widest scope consistent with the principles and features disclosed herein.

An overview of an exemplary cleaning system in accordance with an exemplary embodiment of the present invention will be given, as well as a description of the dynamics of the exemplary cleaning process. In this exemplary embodiment, the exemplary cleaning system includes a processing chamber that is divided or separated into high pressure compartment and a low pressure compartment via a baffle. The baffle may comprise a plate having a number of small holes formed in the baffle that provide a flow path between the two compartments and enable the two compartments to be maintained at substantially different pressures. The low pressure compartment of the processing chamber includes a substrate holder which rotates the substrate during processing. The high pressure compartment includes an inlet port for introducing a liquid mist which may or may not be entrained in the flow of predominant carrier gas injected into the high pressure compartment. Because the two compartments are maintained at substantially different pressures, the pressure differential between the two compartments causes the carrier gas and entrained liquid droplets to accelerate from the high pressure compartment, through the holes in the baffle, and into the low pressure compartment at velocities which may approach the speed of sound (depending the magnitude of the pressure differential) of the carrier gas. One condition which should be maintained for the droplets to attain high speed is that the mass flow rate of the droplets through the nozzles be a small fraction of the mass flow rate of the carrier gas through the same nozzles. If this were not the case the droplets would significantly retard the flow speed of the gas and they would not properly fulfill their function. Because the pressure differential is responsible for accelerating the liquid mist, the holes in the baffle function as tiny nozzles which produce a substantially cone-shaped distribution of liquid mist into the low pressure compartment toward the semiconductor substrate. In some embodiments, the baffle is configured with a sufficient number of holes or nozzles, and the substrate is positioned at an appropriate distance from the baffle, such that each cone projects onto an area of the substrate that overlaps with the projection from an adjacent nozzle. The combined projections from the baffle nozzles should substantially cover the surface area of the substrate to provide a relatively uniform distribution of droplets to the surface of the substrate.

As the droplets propagates toward the substrate, a portion of their mass condenses on the surface of the substrate to form all or part of a liquid film on its facing surface. The substrate may be cooled in some embodiments, such as when the dominant component of the liquid mist is water, to facilitate condensation of the mist, and possibly vapor from the low pressure region, on the substrate. During the cleaning process, the substrate is rotated at a speed sufficient to radially propel the liquid film across the microfeatures of the substrate, and thence off the edge of the substrate. Droplets from the nozzles, however, are continuously impacting onto the rotating substrate to join the liquid film. Accordingly, a steady state may be achieved with regard to the thickness of the liquid film, in which the mass of liquid lost from the film as a result of centrifugal force and splashing is replenished by condensation on the substrate from droplets and ambient vapors in the low pressure region.

Because the liquid film is in contact with microfeatures on the substrate surface, the liquid film can be used to clean waste products away from the vicinity of the microfeatures. Cleaning mechanisms according to embodiments of the present invention are accomplished, in part, by virtue of the agitation of the liquid film. The liquid film is agitated in one of at least two modes, or both modes may work simultaneously. One mode is by the transfer of energy from droplets traveling at high-speed toward and then impinging on the substrate. The second mode is by the viscous flow of the liquid film over the microfeatures of the substrate as the liquid film is radially accelerated off the substrate. Advantages of these embodiments include an efficient cleaning mechanism and a vastly reduced volume of liquid relative to a conventional cleaning bath. A more detailed description of exemplary systems and methods for cleaning semiconductor substrates and the dynamics of the cleaning process will now be presented.

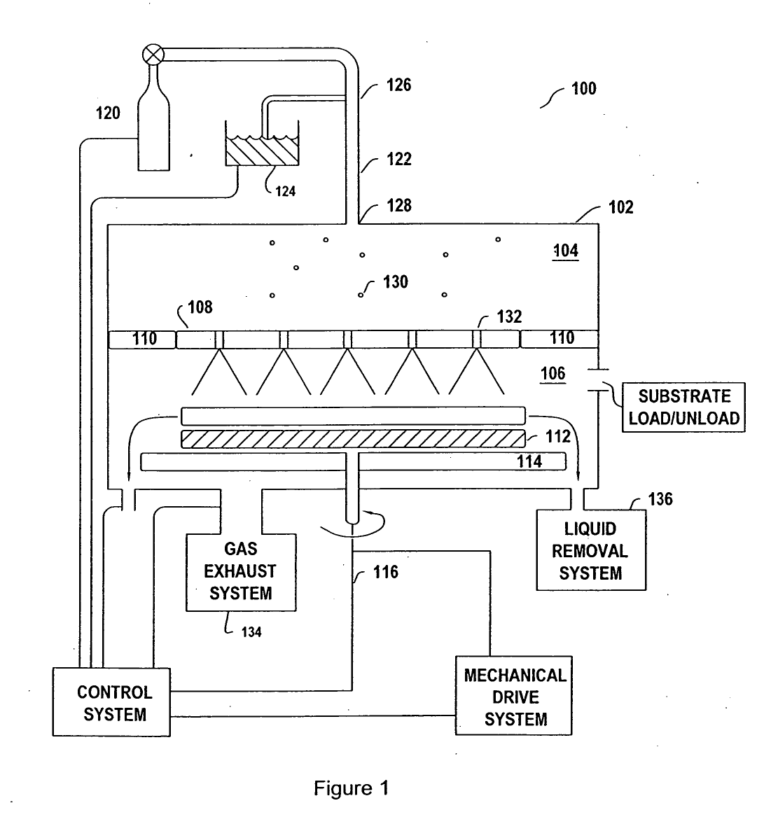

Referring to FIG. 1, an exemplary cleaning system according to embodiments of the present invention is illustrated generally at 100. The exemplary cleaning system includes a processing chamber 102 having a high pressure compartment 104 separated from a low-pressure compartment 106 by a baffle 108 and an extension plate 110. The substrate 112 to be processed is supported by a substrate support 114 which is connected to a shaft 116 so that the substrate 112 may be rotated during processing.

The exemplary system also includes a carrier gas supply 120 for supplying a carrier gas, which may include such gases with high thermal speeds as hydrogen, helium or (other low molecular weight gases such as methane, water vapor) or a mixture including a substantial fraction of hydrogen and helium, into a delivery line 122. A droplet supply 124 also injects a liquid mist into the delivery line 122 to entrain the liquid mist in the carrier gas at position. The liquid droplet supply 124 may comprise a container for holding a liquid cleaning solution and a spray nozzle, liquid injector or another device for generating a mist from the liquid cleaning solution. The liquid droplets entrained in the carrier gas flow are then introduced into the high pressure compartment 104 through port 128 to form droplets 130. A mass flow controller (not shown) may be used to regulate the flow of carrier gas, and may be positioned in the delivery line 122 upstream from the point 126 where the liquid mist is injected. In an alternative embodiment, the droplets may be introduced directly into the high pressure compartment 104 of the processing chamber 102. Preferably, the gas supply 120 and droplet supply 124 are configured to provide droplets 130 having a size on the order of one micron or less in diameter, but it is understood that some of the droplets 130 may also be larger or much smaller than one micron.

The pressure in high pressure compartment 104 may range from about 50 Torr to 5 atmospheres, and is predominantly composed of the carrier gas. The carrier gas generally constitutes the bulk of the pressure (and mass) in the high pressure compartment 104 since the entrained liquid droplets 130 have a low partial pressure (and mass) of their own, and therefore contribute little to the total pressure. A gas exhaust system 134 exhausts gases from the low pressure compartment 106 to maintain the low pressure compartment 106 at a substantially lower pressure than the high pressure compartment 104. The pressure differential between the high pressure compartment 104 and the low pressure compartment 104 causes the droplets 130 to be carried by the carrier gas through the high pressure compartment 104, through holes in the baffle 132 and into the low pressure compartment 106 toward the surface of the substrate 112 being processed.

In some embodiments, it may be advantageous to consider the conditions which would influence the evaporation rate of the droplets 130 in the high pressure compartment 104. In this context, the liquid and temperature of the carrier gas should be chosen such that the evaporation rate of the droplets 130 is not excessive. To make an estimate of the evaporation rate, parameters such as the temperature of the carrier gas and the residence time of the droplets 130 in the high pressure compartment 104 should be taken into consideration. For example, the residence time may be estimated as follows: if the high pressure compartment 104 is maintained at a pressure of about one atmosphere, the volume of high pressure compartment 104 is about 10 liters, and the gas flow of the carrier gas through the compartment 104 is about 10 standard liters per minute, then the residence time is one minute.

The chemical composition of the droplets 130 and the resulting to liquid film on the substrate 112 may comprise a freon, water, alcohol trichloroethylene, base, acid or another cleaning agent, but in some embodiments the droplets 130 may be substantially water-based. Preferably, the chemical composition of the droplets 130 is chosen so that the surface tension of the droplet 130 is low enough to enable the droplets 130 to condense on the substrate 112 to become a part of the liquid film. It may also be advantageous to include a surfactant in the cleaning solution to reduce the surface tension of the droplets 130. In some alternative embodiments, the surfactant may be introduced through the vapor phase, rather than introducing the surfactant through the cleaning solution. The surfactant may also be added to the carrier gas or to the liquid film to help the droplet 130 condense on the substrate 112.

The structure of the baffle 108 separating the high pressure compartment 104 and the low pressure compartment 106 will now be discussed in more detail. Baffle 108 may have a diameter which is comparable to that of substrate 112, but the baffle 108 could also have a range of diameters from about ten percent smaller to about ten percent larger than the diameter of the substrate 112. Extension plate 110 may be configured as a solid plate that fills the space between the baffle 108 and the walls of the processing chamber 102 to maintain the pressure differential between the two compartments 104, 106. The major structural property of extension plate 110 is that it have a thickness sufficient to support the pressure differential while the carrier gas flow not have to be so great that it exceeds the pumping capacity of the vacuum pumps in the low pressure region. Functionally, the extension plate 110 also serves to prevent droplets 130 from impacting on surfaces in the process chamber 102 other than the substrate 112. The baffle 108 may have a circular shape in a plan view, and in this case the extension plate 110 will have an annular shape to correspond to the cylindrical shape of the processing chamber 102.

The nozzles 132 in the baffle 108 are configured to have a length (which may or may not be the same distance as the thickness of the baffle 108) required to impart a desired flow impedance to the carrier gas. The diameters of the nozzles 132 may range from about 0.001 inches to about 0.020 inches. The diameter of the nozzle 132 is generally equal to or less than the diameter of the hole, since the hole may include supplementary features in addition to a nozzle portion.

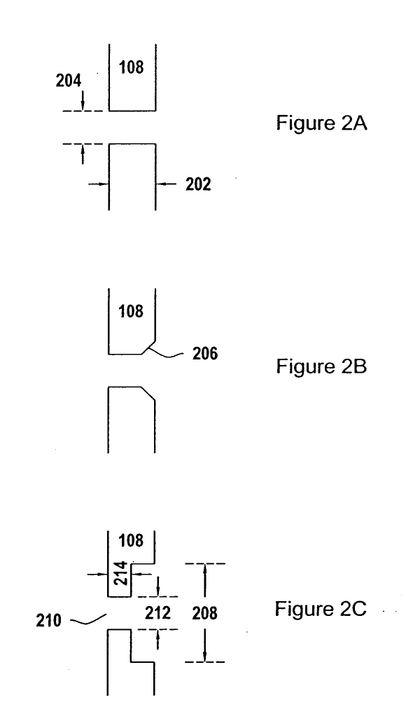

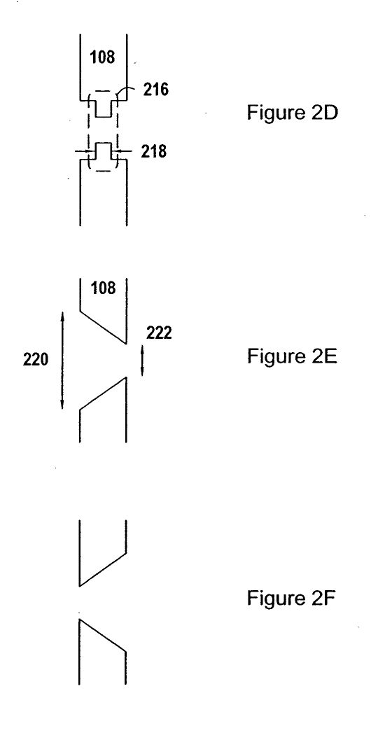

Exemplary nozzle designs are shown in FIGS. 2A-E. A nozzle with straight sides that are perpendicular to the plane of the baffle 108, as well as parallel to one another, is shown in FIG. 2A. In order to realize the desired conductance of the gas and liquid mist, the thickness of the baffle 108 may range from about 2 mm to 5 cm, and is about 1 cm in one embodiment. The thickness of the baffle 108 is represented by dimension 202 in FIG. 2A. Dimension 204 ranges from about 0.001 inches to about 0.020 inches. The sides of the nozzle may be smooth, but they do not necessarily have to be perpendicular to the plane of the baffle 108.

In an alternative embodiment, the nozzle may have the shape shown in FIG. 2B. The flaring 206 on the low-pressure side of the baffle 108 may produce a more desirable distribution of accelerated droplets on their way toward the substrate 112. The flared portion 206 may be categorized as a supplemental feature that may accompany the nozzle portion of the hole.

Another embodiment of a nozzle design is shown in FIG. 2C. The baffle plate in FIG. 2C is counter-bored such that the diameter of the hole is enlarged on the high-pressure side to dimension 208 from the nozzle diameter 212. The nozzle portion is represented by reference numeral 210. Counter-boring the hole produces a desirable nozzle design because the gas conductance for viscous flow is proportional to the fourth power of the diameter of the nozzle (dimension 212) and inversely proportional to the length of the nozzle (dimension 214). In some embodiments, the ratio of dimension 208 to dimension 212 may range from about 2 to 100.

In still other embodiments, the baffle 108 may be counter-bored on both the low and high-pressure sides, such that the nozzle component of the hole is nested in the center region of the baffle 108 as illustrated in FIG. 2D. Referring to FIG. 2D, nozzle 216 is the portion of the baffle hole that accelerates the droplets. The length of nozzle 216 (denoted by reference numeral 218) may be configured to be at least 2 mm.

In still other embodiments, the nozzle may have tapered sides as shown in FIGS. 2E and 2F. The nozzle may taper either toward the high pressure compartment 104, as in FIG. 2E, or toward the low pressure compartment 106, as in FIG. 2F. The ratio of diameter 220 to diameter 218 may range, for example, from about 2 to 3.

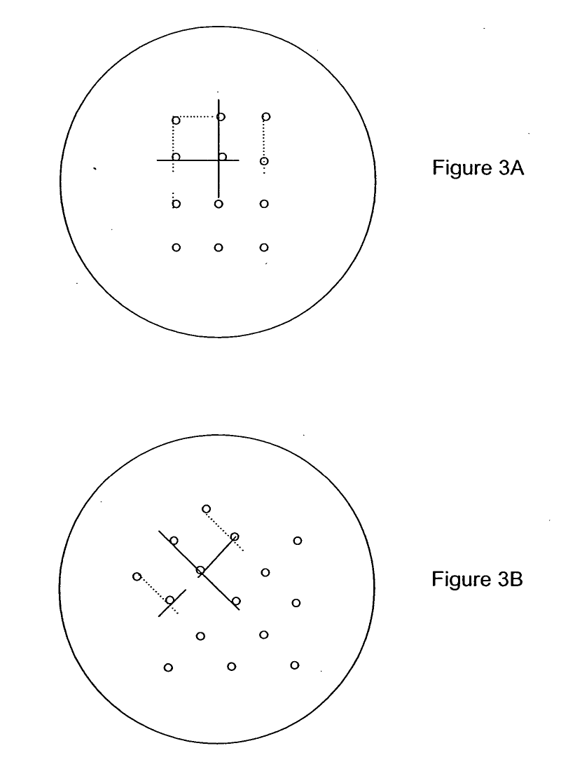

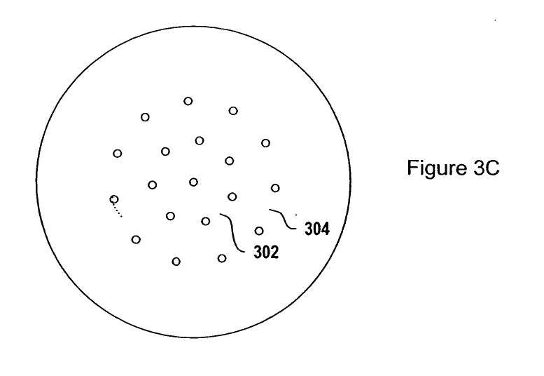

The pattern of holes in the baffle 108 as seen in a plan view may take on a number of different configurations. There are few restrictions on the pattern that the holes may take, although in certain embodiments it may be advantageous to position the holes in the baffle 108 such that they are relatively evenly spaced from one another. Exemplary plan view patterns of an exemplary baffle are shown in FIGS. 3A-C. In FIG. 3A, the holes are placed at the corners of an imaginary geometric lattice comprising an array of a orthogonal lines so that each nozzle is equidistant from its four nearest neighbors. The distance of a nozzle from any of its four nearest neighbors may range, in some embodiments, from about 2 to 3 cm, but of course this distance may be dependent upon the total number of nozzles in the baffle 108. It should be noted that the pattern in FIG. 3B is substantially identical to the pattern of FIG. 3A, except that the lattice in FIG. 3B has been rotated by 45 degrees about an axis perpendicular to the drawing. An alternative pattern as shown in FIG. 3C comprises a series of holes arranged in a concentric circular pattern, two of such patterns illustrated in FIG. 3C by reference numerals 302 and 304.

The appropriate number of nozzles in the baffle is generally dependent upon the substrate area covered by each nozzle. If an exemplary nozzle covers a one cm area of the substrate surface, then roughly 300 nozzles in the baffle 108 would be needed to completely cover an 8 inch substrate. If the exemplary nozzle covers a 10 cm² area of the substrate, then roughly 30 to 35 nozzles would be appropriate.

The appropriate number of nozzles is also dependent upon the distance of separation between the baffle 108 and substrate 112, because the cone-shaped distribution of the droplets increases in spot size as the baffle 108 is moved further away from the substrate 112. The further the substrate is positioned from the baffle, the larger the spot size on the substrate, and the smaller the number of nozzles that will be needed to completely cover the substrate surface.

In exemplary embodiments of the present invention, the distance between the baffle and the substrate may range from between about 1 cm to 50 cm. Table 1 lists exemplary number of nozzles in the baffle that correspond to separation distances of 1, 3, 5, 10, 25, and 50 cm, respectively. This calculation assumes a cone half angle of the droplet stream accelerated out of each nozzle of five degrees, such that the diameter of the spot size (the base of the distribution cone) a distance Z away from the substrate is roughly 0.2 times Z. Thus, for a 5 degree cone half angle and a 10 cm distance of separation between the baffle and the substrate, there will be 2 cm diameter spot size per nozzle and about 100 nozzles will be needed in the baffle to completely cover an 8 inch substrate.

| | | | | | | |
|---|---|---|---|---|---|---|
| Distance of | 1 cm | 3 cm | 5 cm | 10 cm | 25 cm | 50 cm |
| separation | | | | | | |
| Approximate | 1600 | 900 | 400 | 100 | 16 | 4 |
| Number of nozzles | | | | | | |

In one embodiment of the present invention, the temperature of the baffle 108 may be controlled to compensate for the cooling that may occur due to expansion of the carrier gas into the low pressure compartment 106. This baffle should also be at a higher temperature than the wafer in order that there not be excessive condensation of vapor on the baffle either on the high or low pressure side of the baffle.

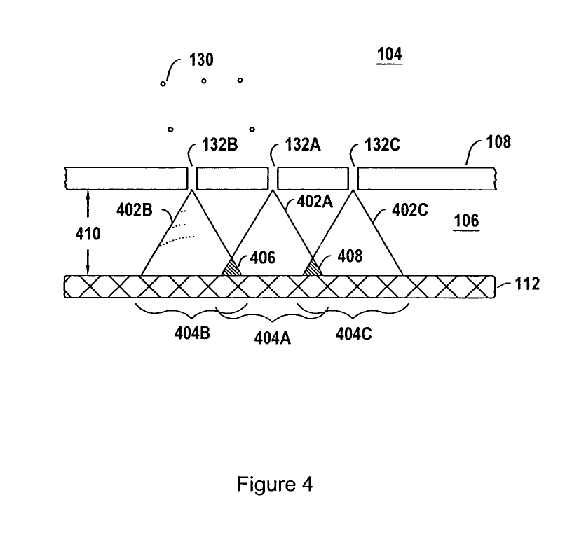

Referring to FIG. 4, each nozzle emits droplets in the shape of a cone, which may be referred to as an emission cone. In one embodiment of the present invention, the baffle is constructed with a sufficient number of nozzles to allow the coverage of adjacent nozzles to overlap. For example, as droplets 130 are induced by the pressure of high pressure compartment 104 to flow through nozzles 132 of baffle 108, the droplets are accelerated through nozzle 132A to form an emission cone 402A in the low pressure compartment 106. The droplets in emission cone 402A project onto substrate 112 with a spot size 404A. The projection of emission cone 402A onto the substrate overlaps with that of adjacent emission cone 402B (404B), with the overlap region indicated by reference numeral 406. Likewise, the projection of emission cone 402A onto the substrate overlaps with that of an adjacent emission cone 402C (404C) on the other side of 402A, and that overlap region is labeled 408. Of course, FIG. 4 is a simplified one-dimensional schematic of a two-dimensional picture, and the overlap of the emission cones on the substrate in two dimensions may take more complicated patterns.

The overlap of the coverage from adjacent nozzles is a function of the distance separating the baffle from the substrate (distance 410 in FIG. 4). Hence, the substrate should be positioned at a distance that is appropriate for a particular nozzle pattern. If the substrate is placed about 10 cm away from the baffle, and if the half angle of the cone is about 10 degrees, then the substrate will have a pattern consisting of cones spaced apart, center to center, by about 3 cm. The “cone angle” should be selected such that it is the cone “full width at half maximum,” or the “cone angle to half maximum” gives a value that is equal to unity at the center?

The droplets propagate from the baffle to the substrate relatively uninhibited by ambient gases in the low-pressure compartment, provided the pressure in the compartment is low enough. The droplets may actually decelerate once they have passed through the baffle as a result of collisions with gas molecules in low pressure region 106. The pressure in region 106 (e.g., the space between the baffle and the substrate) should be low enough to prevent an excessive number of collisions, so that the droplets are not significantly decelerated. If the distance from the baffle to the wafer is smaller than about 10 cm then moderately higher pressures may be tolerated. A pressure of a few Torr or less in the low pressure compartment 106 is not expected to significantly retard the flow of the droplets—we estimate on the order of 10%.

As the droplets travel through the high and low-pressure compartments, the droplets may coalesce to form larger droplets, or they may be reduced in size due to evaporation. Droplets coalescing into larger droplets may not be a common event, since the droplets may simply bounce off one another. Droplets in the high-pressure compartment are of course traveling through a more densely populated environment, but at a much slower speed than droplets that have passed through the baffle into the low pressure compartment. Consequently, they spend more time in the high pressure compartment. Each of these factors plays a role in the amount of evaporation that may occur.

A droplet of liquid traveling with any appreciable speed through a gas at one atmosphere of pressure may experience an undesirable degree of evaporation before getting very far. To reduce the potential for evaporation in the high-pressure compartment, the residence time of the droplets may be reduced. The droplet may physically breakup into smaller droplets, which would contribute to an even greater amount of evaporation rate because of the increased surface area.

Some of these effects may be mitigated by choosing an appropriate temperature of the gas. The temperature of the gas influences the vapor pressure of the liquids comprising the droplets, the latter of which may be on the order of a few Torr or less. This partial pressure is not a significant percentage of an ambient gas at a pressure ranging from 100 Torr to one atmosphere. It is desirable to arrange the partial pressure of the liquid comprising the cleaning droplets to be less than a percent of the ambient pressure to keep the evaporation rate low.

On the other hand, the time it takes a droplet to travel from the baffle to the substrate, after having been accelerated through the nozzles, is much shorter than the time the droplets are confined to the high-pressure compartment. The droplets may travel in the low-pressure compartment at a velocity upp to about 100,000 cm per second or slightly more, and since they may travel only about 10 centimeters, the time they spend on the low-pressure side (as a high-speed droplet) may be a millisecond or less. Although there may be a substantial amount of gas being convected past the droplet, it is believed that the droplet will not evaporate completely because time is so short.

It is difficult to estimate the rate of evaporation of a droplet as it moves at significant fraction of the thermal speed of the carrier gas (for example helium about 1,000 meters per second), at room temperature, and through a 1 Torr ambient pressure of helium. The partial pressure of the liquid in the chamber is considered to be effectively zero, because there is a condensing surface which is condensing the liquid out of the chamber. This means that the rate of evaporation of the droplet under these circumstances is much higher than the rate of evaporation would have been in a stationary, or non dynamic environment at the temperature, because there is convection at high-speed past the droplet in the former case. It is possible that the droplet is evaporating at a rate ten to 100 times its normal rate of evaporation. Fortunately, since the gas is low-pressure, the evaporation rate is not too high.

If there is partial evaporation of the droplets, due to the choice of chemistry, pressure in the low-pressure compartment, temperature, or droplet size, the evaporation effect may be mitigated by starting with larger droplets. In some embodiments, an initial droplet size may be 0.5 microns in diameter, for example, such that a 0.25 micron droplet actually impinges on the substrate after a moderate amount of evaporation.

In any event, a droplet generally needs to survive about 1 second in the high-pressure region, and about 1 millisecond to about 10 milliseconds in the low-pressure, high velocity region. As the droplet moves through the low-pressure region at a speed of up to about 1 kilometer per second, a rough estimate gives an rate of evaporation of approximately 100 times what the rate of evaporation would have been, in that same environment, if the droplet had been motionless. This is an acceptable rate. Furthermore, the fact that the carrier gas is cooled by flow through the nozzles helps to diminish the evaporation rate of the droplets in the low-pressure region.

Droplets arriving at the substrate then impact the surface of the substrate to become part of a liquid film which may have a thickness of one micron or more. At the same time that droplets are impacting the film, ambient vapor from the low-pressure region is condensing on the wafer and the substrate is being rotated to sweep the liquid film radially over the microfeatures of the substrate surface, and thence off the edge of the substrate to be collected as waste. This sweeping of the sheet of liquid centrifugally over the surface of the substrate by rotation of the substrate is a significant component of the present cleaning mechanism, and for this reason the condensed liquid film may be referred to as a “cleaning sheet.” The proper combination of droplet arrival rate, condensation rate, and rotational speed will determine a desired thickness of the cleaning sheet. Two parameters that influence the speed at which the liquid flows off the substrate are viscosity and polarity of the liquid.

As the liquid sweeps across the substrate in a radial fashion, it is continuously bombarded by submicron sized droplets from the vapor phase. The part of these new droplets which remain on the surface replenish the contents of the cleaning sheet with fresh liquid and cleaning agent. Condensation from the low-pressure ambient also contributes to replenishing the sheet. New droplet bombardment also serves to agitate the liquid sheet to help dislodge waste materials from microfeatures, and to mix the waste materials into the cleaning sheet for subsequent removal.

A certain droplet arrival rate is desirable to replenish the cleaning sheet, as well as to provide the necessary agitation. To determine this flux to the substrate, a desired droplet arrival rate of 1 to 10 droplets impinging on each square micron of the liquid sheet surface every second may be converted to a flux to the entire substrate. The surface area of a typical wafer is roughly 300×10⁸ square microns. Stated another way, there are roughly 300×10⁸ cleaning sheet “elements,” each comprising a one square micron surface area. That corresponds to 3×10¹⁰ droplets per 1/10 of a second, up to about 3×10¹⁰ per ten seconds, the latter of which is likely a low impinging rate. In other words, the desired droplet impingement rate according to some embodiments of the present invention ranges from about 3×10⁹ to 3×10¹¹ droplets per substrate per second. More generally, the impingement rate may range from about 10⁹ to 10¹² droplets per substrate per second depending on the size of the droplets. Larger droplets permit a flux to the wafer of lesser numbers of droplets. It may be necessary to generate up to ten times the number of droplets that are actually consumed in cleaning activities. This is because there may be a certain rate of loss of droplets, one mechanism of which includes the condensation on surfaces in the low-pressure compartment other than the substrate. A second potential mechanism of droplet loss is droplets coalescing in the vapor phase to form larger, less useful aggregates.

In yet another embodiment, the flux of droplets to the substrate is 10-100 droplets per square micron of substrate surface area to provide an enhanced degree of agitation of the cleaning sheet than would have been the case with an impingement rate of 1 to 10 droplets per square micron per second. This amount of agitation may be stronger than megasonic agitation.

Cycle time may be considered as the time it takes, on average, for an element of the liquid on the surface of the substrate to be rotated off the edge of the substrate from the time it is formed to the time it is expelled off the edge. The cycle time may be one several seconds or less. The residency time of the liquid on the substrate reduces the opportunity for waste products that have been dislodged from microfeatures and incorporated into the cleaning sheet to be re-deposited onto the substrate, or to adhere to the substrate again.

The rotational speed of the substrate may vary from about 1 to 500 meters per second at the edge of the substrate for a 200 to 300 mm round substrate. A substrate that is revolving at about 100 revolutions per second gives a rotational speed of about 628 radians/sec, such that at a radius of 10 cm, the rotational speed is about 60 meters per second. In some embodiments, the rotational speed may be about 10 meters per second at the edge by substrate. Of course, the speed of revolution decreases in a direction going toward the center of the substrate, and becomes small to negligible near the center.

In some embodiments of the present invention, the substrate is rotated such that an elemental column of liquid spends less than several seconds on the surface of the substrate. Suppose each such element of the liquid is spending about 1 second on the surface of the substrate. Assuming that the layer of the cleaning sheet is about 5 microns thick, and that the substrate is a round wafer with a 200 mm diameter, having an area of approximately 320 cm², the total volume of a particular film of liquid in the cleaning sheet in a one second time period may about 1 mm . In general, the turnover rate of a particular volume of liquid on the substrate in a particular instances time may range from about 0.01 to 100 mm³/sec for a substrate having a diameter of 200 mm. This is to be contrasted with the turnover rate of a volume of liquid used in a conventional bath, which may be calculated by the volume of the bath divided by the number of substrates processed per bath. Often, the bath is changed between each substrate, and the bath is not reused, so that the cleaning volume per substrate is the volume of the bath itself. In the conventional case, the turnover volume of cleaning liquid per substrate may be as high as liters per second.

An important aspect of the present invention is to provide an energetic impingement of droplets to stir the contents of the liquid sheet. The impinging droplets should be energetic enough to agitate the liquid, but not so energetic that the droplets simply “splash off or cause the liquid surface film to be splashed off Droplets that splash off do not become incorporated into liquid film and therefore reduce the efficiency of the cleaning process. Accordingly, there is a balance to be established between agitation and splashing.

One factor that helps to prevent the droplets from simply slashing off is a sufficiently thick cleaning sheet. The cleaning sheet should be thick enough to absorb the energy and the impinging droplets. It is desirable to transfer the energy that the droplets acquire upon being accelerated through the nozzle to the sheet of liquid, such that the liquid in the sheet above the micro features-of the substrate is agitated. In other words, the energy content of the droplets is transferred to the liquid for agitation.

The energy content of a droplet in embodiments of the present invention may represent a significant amount of energy. As the droplet impinges on the surface of the cleaning sheet, it imparts mechanical energy to the cleaning sheet, a portion of which may be converted to thermal energy. This is not necessarily desirable, because the substrate generally needs to be cool to facilitate condensation. In some embodiments, the substrate may be maintained at temperatures from 0 to 20 degrees Centigrade. One mechanism by which the agitation mechanism may occur is through the conduction of sound waves through the liquid from the impinging droplet toward the substrate.

A second factor that may be desirable to avoid, in some embodiments, is the aggregation of liquid into isolated drops on the surface of the cleaning sheet, which may occur in some cases from overly zealous agitation. The conditions of rotational speed, surface tension, condensation rate from vapor, and droplet arrival rate that avoid the aggregated droplet formation on the surface, while at the same time providing a healthy removal rate of contaminants from the surface of the substrate, need to be balanced.

A sub-micron sized droplet hitting the surface at a speed of roughly 1 kilometer per second may contribute to a redistribution of the liquid film from splashing mechanisms. The degree to which the droplet causes a redistribution of the liquid may vary. According to one embodiment of the present invention, the droplets impacting the surface of the liquid sheet do not substantially influence the distribution of liquid in the cleaning sheet.

Assuming that one droplet impinges on each square micron of surface area of the cleaning sheet every 0.1 seconds, and that the square micron element of the cleaning sheet has moved about 1 cm in that time, each elemental column of water will be hit, on the average, roughly 10 times before it flows off the edge of the substrate. Because the square micron of liquid has moved 1 cm, a number of different elemental columns have passed through that location before the next droplet impinges at those same x and y coordinates. Thus, the next droplet that lands at that location is impinging on an entirely different quantity of liquid. Since each quantity of liquid experiences a droplet impinging on it only occasionally, the distribution of liquid in the sheet is not significantly disturbed.

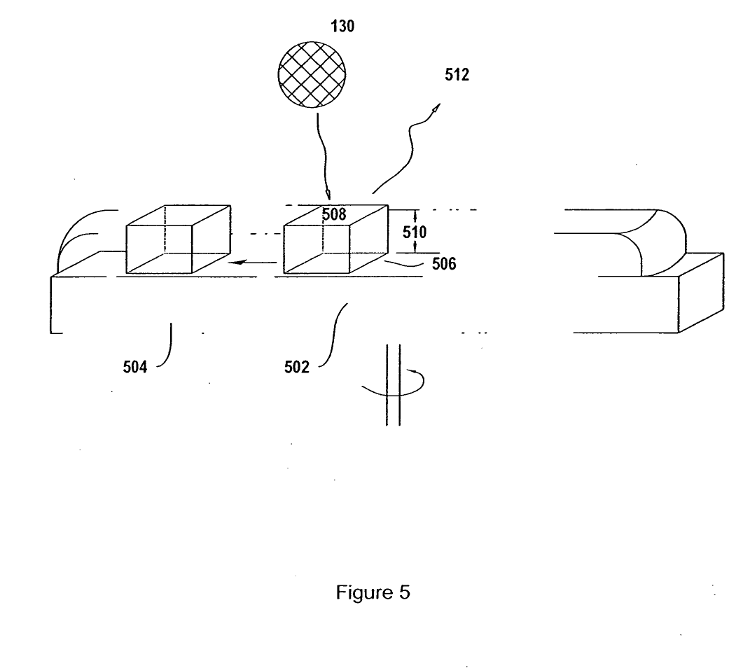

In one form of the calculation, illustrated schematically in FIG. 5, the sheet is moving radially, outward from the center of the substrate from position 502 to 504, at about 10 cm per second. Each square micron of the surface is being impinged every 0.1 seconds by a droplet. Referring to FIG. 5, elemental column of liquid 506 has dimensions 1 by 1 by 5 microns, where the surface area 508 is one square microns, and the height 510 of the elemental column is 5 microns. Spherical droplet 130, having a diameter of 0.25 microns, is impinging on elemental column 506. The droplet volume is about 1/128 cubic microns, and the volume of the element of liquid sheet is about 5 cubic microns. In other words, comparing the relative mass of the droplet to the mass of the element of liquid sheet that that droplet is impinging upon, the mass of the liquid column is about 640 times as large as the mass of the droplet. In general, the mass of the liquid column may be from about 10 to 5000 times as large as the mass of the droplet impinging on that column. This difference in mass implies that the droplet, being much less massive than the column of water, is unlikely to significantly displace the column of water underneath. More specifically, the impinging droplet is unlikely to cause the column of water on the surface to be ejected from or splashed off the substrate in direction 512.

Although it may be unlikely under some conditions for an impinging droplet to eject the column of liquid underneath, such ejection may be encouraged in some embodiments through the use of either larger droplets or more energetic droplets. According to this embodiment, ejection of the liquid column is a convenient and efficient way to remove waste by-products from the substrate much faster than by flowing off the edge of the wafer. As each elemental column of the cleaning sheet flows towards the edge of the substrate, waste products adjacent to the surface of the substrate, near the micro features, diffuse into the column of liquid. The elemental column of liquid may quickly become homogeneous with regard to cleaning liquid and waste products. In other words, the waste products are well mixed in the column in a short distance of travel of that column toward the edge of the substrate. Thus, as waste products are relatively evenly distributed throughout the height of the column, the action of splashing off a portion or all of the column acts to remove waste products from the substrate.

The mixing action is a result of the flow of the cleaning sheet over uneven microfeatures. The scale of the surface roughness of the substrate surface is on the order of one to two microns. Surface irregularities may be on the same order as the thickness of the liquid cleaning sheet above the substrate surface. Splashing may force ejected liquid not only vertically upward, but also outward over the edge of the substrate in a radial direction as well. Each square micron of surface area (the top of each of the elemental columns) has a tangential velocity as it is ejected from the surface. The tangential velocity may be significant if the rotational speed of the substrate is high enough.

The droplet hits the surface in a direction roughly perpendicular to the surface, and would have ejected material in a vertical, upward direction, except for the fact that the substrate has a rotational speed. For substantial portions of the substrate, this translates to a tangential velocity of tens of meters per second. The consequence is that as material is ejected off the surface, it is thrown out radially, and is not likely to fall back down onto the substrate. When it does come back down, it is likely to be well outside the edge of the substrate.

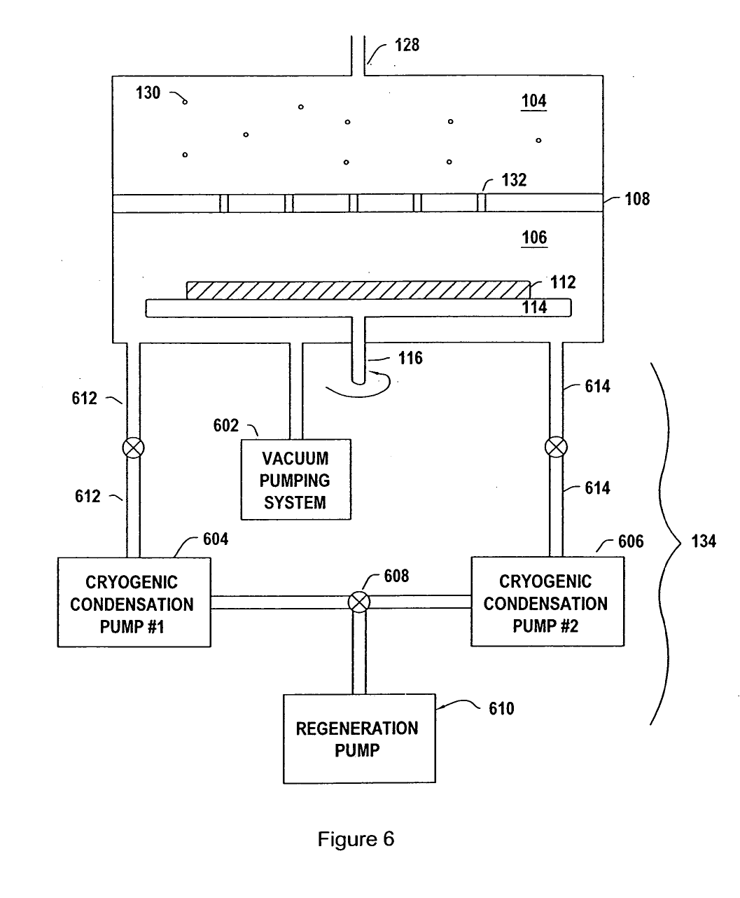

Referring to FIG. 6, there are several options with regard to the gas exhaust system 134 that exhausts gas and waste liquid from the low pressure compartment 106. In one embodiment, a vacuum pumping system 602, such as an oil diffusion pump, direct drive oil pump, roots blower, turbomolecular pump or another vacuum generating device, may be used to exhaust gases from the low pressure compartment 106. An alternative embodiment further includes one or more condensation pumps, such as one or more cryogenic condensation pumps, that are configured to pump liquid waste from the low pressure compartment 106. In some embodiments, there may be redundant cryogenic pumps, such as cryogenic pumps 604 and 606, so that a first pump may be in a regenerative phase while a second pump is operationally exhausting gases and liquids from the compartment 106.

An exemplary pumping system capable of disposing of both liquids and gases is illustrated schematically in FIG. 6. The exemplary pumping system includes a vacuum pumping system 602 configured to primarily remove gases from the low pressure compartment 106. To remove significant amounts of liquid, the exemplary pumping system may also use condensation pumps 604 and 606. A desirable feature of the condensation pumps 604 and 606 is that the pumps may be configured to operate at liquid carbon dioxide temperatures (rather than liquid nitrogen temperatures) to more aggressively condense the waste liquid into the pumping system. This approach may be especially desirable when the majority component of the waste liquid is water.

The dual or redundant condenser pumps 604 and 606 may also be configured to operate in conjunction using valve 608 such that while one pump 604 is pumping gases and liquid from the compartment 106 (and is being packed with liquid), the other pump 606 is being regenerated by regeneration pump 610. As a result, the processing chamber may be configured to run with high efficiency by having a first pump 604 operationally pumping while a second pump 606 is being regenerated, and vice versa. A desirable criteria for the regeneration pump 610 is that it have the capability of pumping significant quantities of water-based vapor at relatively high pressures. In some embodiments, it is not intended to be the same type of pump as a conventional vacuum pump designed to exhaust carrier gases from compartment 106. It should be further noted that in some embodiments, exhaust lines 612 and 614 may be high conductance exhaust lines.

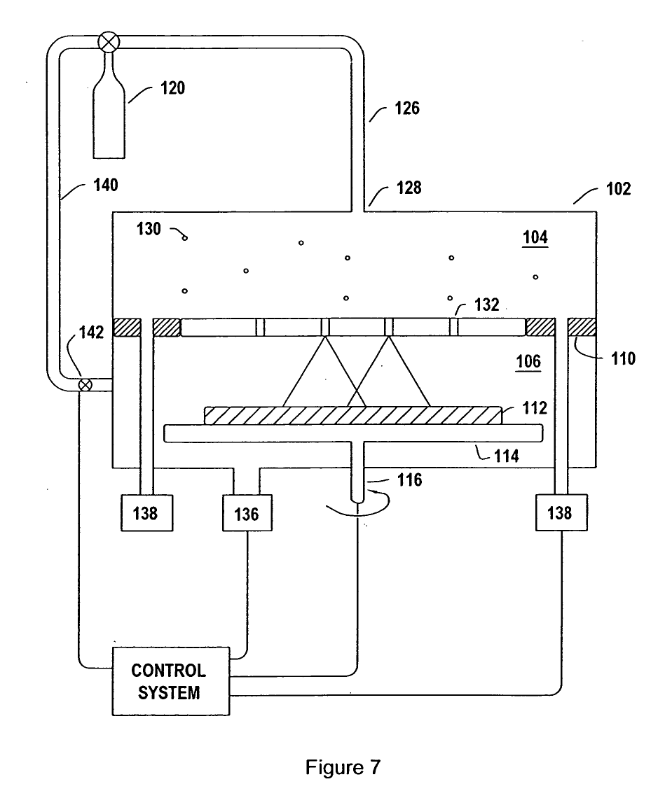

Referring to FIG. 7, a separate liquid collection system 136 may be a desirable additional component of the gas and vapor exhaust system 134, especially in cases where the walls of the processing chamber are not heated. Because an unheated chamber wall will tend to condense more liquid from the vapor than in cases where the chamber walls are heated, a liquid collection system 136 may be configured to remove liquid that has condensed on the chamber walls in the low pressure compartment 106 and reduce the required load on the condensation pumps 604 and 606. In another embodiment, a second liquid collection system 138 (similar to liquid collection system 136) may also be included to remove liquid that has condensed on the chamber walls in the high pressure compartment 104. There is also an alterative embodiment of this invention where the walls are kept somewhat warmer than the wafer holding pedestal so that condensation of vapor on the wafer is encouraged in preference to condensation on the walls. In some embodiments we would like to avoid such wall condensation since the vapors may be expensive to produce. It is also likely to be important that the walls not be too hot since they should not in some embodiments be causing excessive evaporation of droplets string the walls.

In other embodiments it where it may be useful or necessary to cool the walls the vapors may be injected through a separate nozzle directed with some moderate flow speed directly at the wafer to provide condensation on it.

One potential problem that may arise with the cleaning system involves the clogging of the holes in the baffle, which may arise from short term effects, such as the liquid from the droplets partially or completely stopping up the holes to impede any further flow of liquid mist through the baffle. On a longer time scale, solids or other forms of debris may gradually come out of solution to be deposited within the holes to clog the baffle. Additionally, there may be unwanted materials splashed from the substrate onto the low pressure side of the baffle, partially filling nozzles, and further hampering the flow of the carrier gas and the entrained liquid mist. These potential problems may be resolved by, for example, shutting off the droplet supply from the carrier gas flow, pulsing the carrier gas flow at high pressure during normal processing, back flushing the carrier gas through the baffle from compartment 106 to compartment 104, or megasonically or ultrasonically shaking the baffle 108 to shake lose any obstructions from the baffle nozzles.

In one embodiment, a cleaning or unclogging cycle may be implemented by flowing the carrier gas, without the entrained droplet mist, to clear out obstructions from the holes in the baffle. In this embodiment, the droplet mist from droplet supply 124 is shut off such that only the carrier gas from supply 120 is flowed into compartment 104. In other embodiments, high pressure pulses of the carrier gas may be used to clear the holes in the baffle. These high pressure pulses can be used to breakup liquid and/or solid deposits blocking the nozzles. A process step in which the droplet flow is turned off such that only carrier gas is flowed through the baffle may be included as a routine step in the cleaning process recipe. In other words, the droplet stream from the droplet supply in some process embodiments need not be continuous.

In a second embodiment of a baffle unclogging process, a back-flushing step may be employed in which the carrier gas is supplied through a delivery line 140 (shown in FIG. 7) to the low pressure side 106, and in a temporary manner, the role of the two compartments 104 and 106 is reversed such that the low pressure side 106 is maintained at a higher pressure than the high pressure compartment 104. Referring to FIG. 7, a valve 142 may be used to control the flow of the carrier gas to the compartment 106 during the back-flushing procedure, and to stop the flow after the procedure has been completed. By configuring the compartments in this manner, materials obstructing the nozzles may be blown into compartment 104. It is likely that substrate 112 would be removed from compartment 106 in this embodiment before the back-flushing procedure is initiated. In other words, back-flushing would most likely constitute a separate cleaning step performed in the absence of the substrate. In a third embodiment, the baffle itself may be vibrated to shake loose obstructing materials from the nozzles. The frequency of the vibrations may be within an ultrasonic or megasonic range of frequencies. While the present invention has been described with reference to exemplary embodiments, it will be readily apparent to those skilled in the art that the invention is not limited to the disclosed embodiments but, on the contrary, is intended to cover numerous other modifications and broad equivalent arrangements that are included within the spirit and scope of the following claims.

What is claimed:

1. A system for cleaning a semiconductor substrate, the system comprising:
a processing chamber divided into a high pressure compartment and a low pressure compartment via a baffle, the baffle including a plurality of apertures formed therein for providing a flow path between the high pressure compartment and the low pressure compartment;
an inlet port configured to inject a gas and a liquid mist of fine droplets into the high pressure compartment such that at least a portion of the gas and droplets flow through the baffle into the low pressure compartment; and
a rotable substrate support, positioned within the low pressure compartment, configured to rotate the substrate such that droplets impacting on the surface of the substrate condense and flow radially across the substrate for cleaning.

2. The system of claim 1, further comprising a supply system configured to supply the gas and the liquid mist to the inlet port.

3. The system of claim 1, further comprising a supply system configured to control the flow rate of the liquid mist such that the liquid mist impacting on the surface of the substrate helps form a liquid film having a steady state thickness.

4. The system of claim 3, wherein the supply system is further configured to control the pressure differential between the high pressure compartment and the low pressure compartment such that the liquid mist flows through the baffle toward the substrate at a desired velocity.

5. The system of claim 2, wherein the supply system is configured to supply a surfactant to the liquid mist to reduce the surface tension of the liquid mist.

6. The system of claim 1, further comprising an exhaust system for pumping the gas and the liquid mist from the low pressure compartment.

7. The system of claim 6, wherein the exhaust system comprises a vacuum pump and at least one condensation pump.

8. The system of claim 7, wherein the exhaust system further comprises a regeneration pump coupled to the at least one condensation pump.

9. The system of claim 6, further comprising a liquid collector configured to remove condensed liquid from at least one of the low pressure compartment and the high pressure compartment.

10. The system of claim 1, further comprising a source of vapors which is connection to the low-pressure section of the system to provide a source of liquid condensation of the wafer surface.

11. The system of claim 10, in which the condensation from the vapor is in order to balance the loss from the wafer surface due to centrifugal flow and splashing.

12. The system of claim 1, wherein the liquid mist flowing through each of the plurality of apertures projects a cone-shaped distribution pattern toward the substrate, and wherein each of the plurality of apertures is configured such that the distribution pattern of each aperture overlaps the distribution pattern of at least one adjacent aperture.

13. The system of claim 1, wherein the side walls defining each of the plurality of apertures formed in the baffle are substantially perpendicular to the plane of the baffle.

14. The system of claim 1, wherein each of the plurality of apertures formed in the baffle has a larger diameter toward the high pressure compartment than toward the low pressure compartment.

15. The system of claim 15 wherein the diameter of each of the plurality of apertures varies continuously from the high pressure compartment toward the low pressure compartment.

16. The system of claim 14 wherein each of the plurality of apertures comprises a counter-bored aperture.

17. The system of claim 1, further comprising a control system configured to adjust the rotational speed of the substrate support in accordance with a desired flow speed of the condensed liquid across the substrate.

18. A method for cleaning a semiconductor substrate, comprising:
separating a processing chamber into a high pressure compartment and a low pressure compartment using a baffle, the baffle having a plurality of apertures formed therein for providing a flow path between the high pressure compartment and the low pressure compartment;
positioning the substrate to be cleaned in the low pressure compartment;
injecting a gas and a liquid mist in the high pressure compartment such that at least a portion of the gas and the liquid mist flows through the baffle into the low pressure compartment;
rotating the substrate at a speed sufficient to flow portions of the liquid mist condensing on the surface of the substrate radially across the substrate for cleaning.

19. The method of claim 18, further comprising controlling the flow rate of the liquid mist such that the liquid mist condensing on the surface of the substrate forms a liquid film having a steady state thickness.

20. The method of claim 19, further comprising adjusting the pressure differential between the high pressure compartment and the low pressure compartment such that the liquid mist flowing through the baffle toward the substrate impinges on the liquid film at a desired velocity.

21. The method of claim 19, further comprising adding a surfactant to the liquid mist to reduce the surface tension of the liquid mist.

22. The method of claim 12, further comprising pumping the gas and the liquid mist from the low pressure compartment.

23. The method of claim 22, wherein the step of pumping comprising pumping the gas and the liquid mist using a vacuum pump and at least one condensation pump.

24. The method of claim 23, wherein the step of pumping further comprises using a regeneration pump coupled to the at least one condensation pump.

25. The method of claim 22, further comprising removing condensed liquid from at least one of the low pressure compartment and the high pressure compartment.

26. The method of claim 18, further comprising the rotational speed of the substrate in accordance with the desired flow speed of the condenses liquid across the substrate.

27. A system for cleaning a semiconductor substrate using a reduced volume of liquid, the system comprising:
a processing chamber divided into a high pressure compartment and a low pressure compartment via a baffle;
a rotable substrate support, positioned within the low pressure compartment, configured to rotate the substrate during processing;
a supply system configured to supply a liquid mist and a carrier gas into the high pressure compartment, the pressure differential between the high pressure compartment and the low pressure compartment maintained so as to accelerate the liquid mist through the baffle toward the substrate; and
wherein the substrate support is configured to rotate at a speed sufficient to radially flow a portion of the liquid mist condensing on the substrate radially across the substrate to affect cleaning.

28. The system of claim 27, wherein the supply system is configured to adjust the pressure differential between the high pressure compartment and the low pressure compartment to adjust the velocity at which the liquid droplets impinges upon the surface of the substrate.

29. The system of claim 28, wherein the supply is further configured to adjust flow rate of the liquid mist to adjust the steady state thickness of the portion of the liquid condensing on the substrate.

30. The system of claim 27, wherein the supply system is configured to periodically increase the pressure in the low pressure compartment above the pressure in the high pressure compartment to unclog the baffle.

31. The system of claim 27, wherein there is a supply of vapor to the low pressure side of the baffle so as to provide for liquid condensation on the wafer.

32. The system of claim 25, wherein the supply system is configured to periodically pulse the supply of gas into the high pressure compartment to unclog the baffle.

33. The system of claim 27, further comprising a removal system configured to remove the gas and entrained liquid mist from the low pressure compartment.

34. The system of claim 33, wherein the removal system further comprises a liquid collector for removing condensed liquid from the processing chamber.

35. The system of claim 27, further comprising a controller configured to adjust the orational speed of the substrate support in accordance with desired cleaning characteristics.
